(19) United States
(12) Patent Application Publication
(10) Pub. No.: US 2019/0169356 A1
(43) Pub. Date: Jun. 6, 2019

(54) EPOXY RESIN COMPOSITION, PREPREG, AND FIBER REINFORCED PLASTIC MATERIAL

(71) Applicant: Toray Industries, Inc., Tokyo (JP)

(72) Inventors: Swezin Than Tun, Tacoma, WA (US); Jonathan Hughes, Tacoma, WA (US); Nobuyuki Arai, Tacoma, WA (US); Benjamin Lehman, Tacoma, WA (US)

(73) Assignee: Toray Industries, Inc., Tokyo (JP)

(21) Appl. No.: 16/323,147

(22) PCT Filed: Aug. 24, 2017
(86) PCT No.: PCT/IB2017/001172

§ 371 Date: Feb. 4, 2019

Related U.S. Application Data
(60) Provisional application No. 62/380,033, filed on Aug. 26, 2016.
(60) Provisional application No. 62/539,101, filed on Jul. 31, 2017.

(51) Int. Cl. C08G 59/32; C08G 59/40; C08G 59/42; C08G 59/68; C08G 59/38; C08J 5/24; C08J 5/04

(52) U.S. Cl. CPC C08G 59/3227; C08G 59/4021; C08G 59/4223; C08J 2363/00; C08G 59/38; C08J 5/24; C08J 5/04; C08G 59/686

(57) ABSTRACT

The embodiments herein relate to an epoxy resin composition containing a specific type of amine-based epoxy resin containing four epoxy groups per molecule, a prepreg, and a fiber-reinforced composite material. More specifically, the embodiments herein relate to an epoxy resin composition containing a combination of particular types of epoxy resin and curatives that provides high flexural modulus that is suitable for preparing a fiber-reinforced composite material capable of withstanding extreme use environments such as low-temperature environments and high-temperature moisture-absorbing environments. In addition, the embodiments herein relate to epoxy resin systems capable of achieving a high degree of cure (e.g., 85% or more) within a relatively short period of time (e.g., less than two hours) at a relatively low temperature (e.g., 132° C.).

### CROSS-REFERENCE TO RELATED APPLICATIONS

This is the U.S. National Phase application of PCT/IB2017/001172, filed Aug. 24, 2017, which claims priority to U.S. Provisional Application No. 62/380,033, filed Aug. 26, 2016 and U.S. Provisional Application No. 62/539,101, filed Jul. 31, 2017, the disclosures of each of which are incorporated herein by reference in their entirety for all purposes.

### FIELD OF THE INVENTION

The present application provides an epoxy resin composition for fiber-reinforced composite materials that are well-suited for aerospace applications, sports applications, and general industrial applications.

### BACKGROUND OF THE INVENTION

Fiber Reinforced Plastic (FRP) materials comprising a reinforced fiber and a matrix resin have excellent mechanical properties such as strength and rigidity while being lightweight, and therefore are widely used as aircraft members, spacecraft members, automobile members, railway car members, ship members, sports apparatus members, and computer members such as housings for laptops. The FRP materials are produced by various methods, and among the methods, it is widely practiced using reinforcing fibers impregnated with an unhardened matrix resin, as a prepreg. In this method, sheets of prepreg are laminated and heated, to form a composite material. The matrix resins used for prepregs include both thermoplastic resins and thermosetting resins, in most cases; thermosetting resins are excellent in handling. Amongst these, epoxy resins, which provide outstanding characteristics such as high heat resistance, high elastic modulus, low shrinkage on curing and high chemical resistance, are most often employed.

The FRPs' properties depend on both the reinforcement fibers and the matrix resin. The important design properties include tensile strength and modulus, compression strength and modulus, impact resistance, damage tolerance, and toughness. In general FRP materials, the reinforcing fibers contribute the majority of the properties. On the other hand, the matrix resin has greatest impact on compression strength and transverse tensile properties. When the FRP materials are used as structural materials, compression strength is an especially important property.

It is believed that high resin flexural modulus is directly correlated to high compression strength of the FRP materials. Small increases of resin flexural modulus can greatly improve the compression strength of the FRP composites which then significantly influences weight reduction in many applications such as spacecraft and automotive industries. Additionally, the matrix resin with high flexural modulus can provide high heat resistance. Thus, the development of high performance resins where the resin flexural modulus is as high as possible without deleteriously affecting the other properties has been, and continues to be, a major goal of the aerospace and automotive industries, general aviation companies and spacecraft manufacturers.

To enhance the compression strength of the FRP materials, it is essential to enhance the flexural modulus of the resin as much as possible. For enhancing the resin flexural modulus, it has been proposed to use epoxy resins having high crosslinking density. In conventional composites, N,N,N′,N′-tetraglycidyl-4,4′-diaminodiphenyl methane epoxy is typically used in the matrix resin. Due to the four functional epoxide groups, the resin has high crosslinking providing high flexural modulus and high heat resistance, but it does not have sufficient compression strength. Many prior attempts had been made in U.S. Pat. Nos. 8,263,216 and 20140235757, and European Publication No. 2551288, using different types of epoxy having four functional epoxide groups to provide high flexural modulus resulting in high tensile strength and compression strength. All those abovementioned prior attempts used diaminodiphenyl sulfone curative which required molding temperature of approximately 160° C. or higher for about 2-6 hours. Thus, they are somewhat limited to certain molding processes and production rates.

To achieve high production volumes using low price tooling processes such as out-of-autoclave processes, the curing temperature needs to be relatively low at approximately 100-150° C. for roughly 1-2 hours. One of the most well-known fast curatives is dicyandiamide (DICY) which provides low temperature curability. For example, U.S. Pat. Publication Nos. 20130217805 and 2014235757 disclose that an epoxy resin composition containing DICY and Urea provides low temperature curability. However, these composites have very low heat resistance and short shelf-life and thus are not suitable for aerospace applications. Another example, U.S. Pat. Publication No. 20140100320, discloses that an epoxy resin composition with aromatic amines and aliphatic amines in combination provides low temperature curability having long shelf-life as well as relatively high modulus. However, the composite flexural modulus obtained is not high enough for certain applications such as primary and secondary structural spacecraft components which are exposed to excessive heat and humidity.

Therefore, the present invention seeks to provide an epoxy resin composition that can be cured at low temperature to form a cured product excellent in flexural modulus and high heat resistance that prior attempts have failed to achieve. Another object is to provide an FRP material that has superior properties while maintaining low temperature curability.

### SUMMARY OF THE INVENTION

In one aspect of the invention, an epoxy resin composition for a fiber-reinforced composite material is provided, comprising components (A), (B) (an optional component), (C), and (D), wherein the epoxy resin composition has a degree of cure of at least 90% after being cured at 132° C. for 2 hours and a room temperature flexural modulus of at least 4.5 GPa after being cured at 132° C. for 2 hours, wherein the components (A), (B), (C), and (D), comprise, consist essentially of, or consist of:
(A) at least 20 phr in total per 100 phr of total epoxy resin of at least one tetrafunctional amine-based epoxy represented by formula (1), wherein X is a divalent moiety having a molecular weight of at least 15 g/mol and R₁ to R₄ are each independently selected from the group consisting of a hydrogen atom, halogen atoms, C₁ to C₆ alkyl groups, C₁ to C₆ alkoxyl groups, C₁ to C₆ fluoroalkyl groups, cycloalkyl groups, aryl groups, and aryloxyl groups wherein these groups are optionally employed individually or different groups are optionally employed in combination as each of R₁ to R₄;

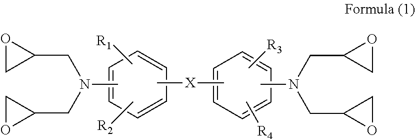

(B) optionally, at most 80 phr in total per 100 phr of total epoxy resin of at least one epoxy resin other than component A;
(C) at least one amine-based curing agent, wherein components (A), (B), and (C) are present in amounts effective to provide a molar ratio of active hydrogens:epoxy groups ranging from 0.2:1 to 0.9:1; and
(D) at least one urea-based catalyst.

This invention further includes a cured epoxy resin obtained by curing the abovementioned epoxy resin composition, a prepreg obtained by impregnating a reinforcing fiber matrix with the abovementioned epoxy resin composition, a fiber-reinforced composite material obtained by curing the prepreg, and a fiber-reinforced composite material comprising a cured product obtained by curing a prepreg comprising the abovementioned epoxy resin composition and a reinforcing fiber base.

After extensive studies, the inventors have surprisingly discovered that when a specific type of tetrafunctional amine-based epoxy is employed in an epoxy resin composition, it is possible to achieve a very high flexural modulus in a cured resin, thus further providing better overall properties. This was unexpected, at least in part because the prior art references employing such epoxy resins only recognized that such epoxy resins result in impact resistance and tensile strength improvement of the cured resins.

Without wishing to be bound by theory, including a high electro-negative component in a tetrafunctional amine-based epoxy is believed to increase the dipole moment of the compound, thus increasing the intermolecular interaction or hydrogen bonding of the polymer network formed by curing a composition comprising this epoxy and increasing the flexural modulus of the cured resin.

### DETAILED DESCRIPTION OF CERTAIN EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The terms “approximately”, “about” and “substantially” as used herein represent an amount close to the stated amount that still performs the desired function or achieves the desired result. For example, the terms “approximately”, “about”, and “substantially” may refer to an amount that is within less than 10% of, within less than 5% of, within less than 1% of, within less than 0.1% of, or within less than 0.01% of the stated amount.

The term “room temperature” as used herein has its ordinary meaning as known to those skilled in the art and may include temperatures within the range of about 15° C. to 43° C.

The term “low temperature cure” as used herein includes curing at temperatures within the range of about 110° C. to about 150° C.

Component (A) comprises at least one epoxy resin which is a tetrafunctional amine-based epoxy represented by formula (1):

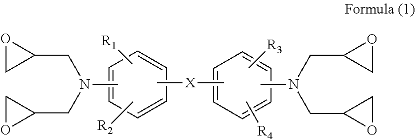

wherein X is a divalent moiety having a molecular weight of at least 15 g/mol. “Tetrafunctional” refers to the presence of four epoxy functional groups in the epoxy resin molecule, in the form of glycidyl groups attached to nitrogen atoms. In one embodiment, X is a moiety that comprises at least one heteroatom, such as N (nitrogen), O (oxygen) or S (sulfur). In other embodiments, X is a moiety selected so as to provide the tetrafunctional amine-based epoxy with a dipole moment of at least 0.5 Debye, at least 0.7 Debye, at least 1 Debye, at least 1.5 Debye, or at least 2 Debye. Dipole moment values can be experimentally obtained by measuring the dielectric constant and refractive index data as a function of temperature. The electrical dipole moment values are measured in benzene solution at a temperature of 25° C. In particular, the method described in the following publication may be used to measure dipole moment: Hampson, G. C., Farmer R. H., and Sutton L. E. “The Determination of the Valency Angles of the Oxygen and Sulphur Atoms and the Methylene and Sulphoxy Groups, from Electric Dipole Moments.” Proceedings of the Royal Society of London. Series A, Containing Papers of a Mathematical and Physical Character 143.848 (1933). L. G. Wesson, Tables of Electric Dipole Moments, Technology Press, Cambridge, Mass., 1948, contains listings of dipole moment values for various compounds. Examples of suitable X moieties are sulfur —S—, sulfone —SO₂—, ether —O—, carboxyl —C(═O)O—, amide —C(═O)NH—, carbonyl (keto) —C(═O)—, amino —NR₅—, imide —C(═O)NR₆C(═O)—, urea —NR₇C(═O)NR₈—, urethane —OC(═O)NR₉— and carbonate —OC(═O)O—. Component (A) may be comprised of two or more tetrafunctional amine-based epoxies having different X moieties (for example, both ether and sulfone moieties). R₁ to R₄ in Formula (1) are each independently selected from the group consisting of a hydrogen atom, halogen atoms, C₁ to C₆ alkyl groups, C₁ to C₆ alkoxyl groups, C₁ to C₆ fluoroalkyl groups, cycloalkyl groups, aryl groups, and aryloxyl groups wherein these groups are optionally employed individually or different groups are optionally employed in combination as each of R₁ to R₄. Within the X moieties, R₅ to R₉ are each independently selected from the group consisting of a hydrogen atom, C₁ to C₆ alkyl groups, C₁ to C₆ fluoroalkyl groups, cycloalkyl groups, and aryl groups, wherein these groups are optionally employed individually or different groups are optionally employed in combination as each of R₅ to R₉.

Some non-limiting examples of component (A) epoxy resins corresponding to Formula (1) include tetraglycidyl-3,4′-diaminodiphenyl ether, tetraglycidyl-3,3′-diaminodiphenyl ether, tetraglycidyl-3,4′-diamino-2,2′-dimethyldiphenyl ether, tetraglycidyl-3,4′-diamino-2-2′-dibromodiphenyl ether, tetraglycidyl-3,4′-diamino-5-methyldiphenyl ether, tetraglycidyl-3,4′-diamino-4′-methyldiphenyl ether, tetraglycidyl-3,4′-diamino-3′-methyldiphenyl ether, tetraglycidyl-3,4′-diamino-5,2′-dimethyldiphenyl ether, tetraglycidyl-3,4′-diamino-5,3′-dimethyldiphenyl ether, tetraglycidyl-3,3′-diamino-5-methyldiphenyl ether, tetraglycidyl-3,3′-diamino-5,5′-dimethyldiphenyl ether, tetraglycidyl-3,3′-diamino-5,5′-dibromodiphenyl ether, tetraglycidyl-4,4′-diaminodiphenyl ether, tetraglycidyl-4,4′-diamino-2,2′-dimethyldiphenyl ether, tetraglycidyl-4,4′-diamino-2,2′-dibromodiphenyl ether, tetraglycidyl-4,4′-diamino-5′-methyldiphenyl ether, tetraglycidyl-4,4′-diamino-2′-methyldiphenyl ether, tetraglycidyl-4,4′-diamino-3′-methyldiphenyl ether, tetraglycidyl-4,4′-diamino-5,2′-dimethyldiphenyl ether, tetraglycidyl-4,4′-diamino-5,3′-dimethyldiphenyl ether, tetraglycidyl-4,4′-diamino-5,5′-dimethyldiphenyl ether, tetraglycidyl-4,4′-diamino-5,5′-dibromodiphenyl ether, tetraglycidyl-3,4′-diaminodiphenyl sulfone, tetraglycidyl-3,3′-diaminodiphenyl sulfone, tetraglycidyl-3,4′-diamino-2,2-dimethyldiphenyl sulfone, tetraglycidyl-3,4′-diamino-2,2′-dibromodiphenyl sulfone, tetraglycidyl-3,4′-diamino-5-methyldiphenyl sulfone, tetraglycidyl-3,4′-diamino-2′-methyldiphenyl sulfone, tetraglycidyl-3,4′-diamino-3′-methyldiphenyl sulfone, tetraglycidyl-3,4′-diamino-5,2′-dimethyldiphenyl sulfone, tetraglycidyl-3,4′-diamino-5,3′-dimethyldiphenyl sulfone, tetraglycidyl-3,3′-diamino-5-methyldiphenyl sulfone, tetraglycidyl-3,3′-diamino-5,5′-dimethyldiphenyl sulfone, tetraglycidyl-3,3′-diamino-5,5′-dibromodiphenyl sulfone, tetraglycidyl-4,4′-diaminodiphenyl sulfone, tetraglycidyl-4,4′-diamino-2,2′-dimethyldiphenyl sulfone, tetraglycidyl-4,4′-diamino-2,2′-dibromodiphenyl sulfone, tetraglycidyl-4,4′-diamino-5-methyldiphenyl sulfone, tetraglycidyl-4,4′-diamino-2′-methyldiphenyl sulfone, tetraglycidyl-4,4′-diamino-3′-methyldiphenyl sulfone, tetraglycidyl-4,4′-diamino-5,2′-dimethyldiphenyl sulfone, tetraglycidyl-4,4′-diamino-5,3′-dimethyldiphenyl sulfone, tetraglycidyl-4,4′-diamino-5,5′-dimethyldiphenyl sulfone, tetraglycidyl-4,4′-diamino-5,5′-dibromodiphenyl sulfone, tetraglycidyl-4,4′-diaminodiphenyl thioether, tetraglycidyl-4,4′-diamino benzyl benzoate, tetraglycidyl-3,4′-diamino benzyl benzoate, tetraglycidyl-4,4′-diamino phenyl benzoate, tetraglycidyl-3,4′-diamino phenyl benzoate, tetraglycidyl-4,4′-diaminobenzanilide, tetraglycidyl-3,3′-diaminobenzanilide, and tetraglycidyl-3,4′-diaminobenzanilide. It should be noted that the epoxy resins suitable for use in component (A) are not restricted to the examples above. Furthermore, mixtures of two or more of these epoxy resins, for instance, a mixture of tetraglycidyl-4,4′-diaminodiphenyl ether and tetraglycidyl-3,3′-diaminodiphenyl sulfone, can be employed in the formulation of the epoxy resin composition. Without wishing to be bound by theory, it is believed that component (A) epoxy resin, herein a specific type of tetrafunctional amine-based epoxy in the composition, provides very high flexural modulus and heat resistance once the epoxy resin composition has been cured. Abovementioned component (A) is an essential component for an epoxy resin composition to successfully provide excellent flexural modulus. Furthermore, mixtures of two or more of these epoxy resins can be employed in the formulation of the epoxy resin composition.

The amount of component (A) is at least 20 phr per 100 phr of total epoxy resin. If the amount is less than 20 phr, the resin flexural modulus will be too low and the FRP material obtained will have low compression strength.

Examples of commercially available products suitable for use as component (A) include tetraglycidyl diaminodiphenyl ether, S-722M and S-722 (manufactured by Synasia Fine Chemical Inc.); 3,3′-TGDDE (manufactured by Toray Fine Chemicals Co. Ltd.); and tetraglycidyl diaminodiphenyl sulfone, TG3DAS (manufactured by Konishi Chemical Ind. Co., Ltd. or Mitsui Fine Chemicals, Inc.).

The cured epoxy resin composition comprising component (A) is capable of being cured at 132° C. for 2 hours to achieve a degree of cure (“DoC”) of at least 90%. If the degree of cure is less than 90%, the cured resin will have low heat resistance and the FRP material obtained will have low mechanical properties. The DoC of an epoxy resin composition can be determined by use of a Differential Scanning calorimeter (DSC, manufactured by TA Instruments). The DoC value is obtained by empirically comparing the exothermic reaction peak area of an uncured resin (ΔH_{uncured}) against the residual exothermic reaction peak area of a cured resin (ΔH_{cured}). Herein, the DoC can be calculated by the following formula:

$$Degree of Cure , DoC ( \% ) = \frac{Δ {H}_{uncured} - Δ {H}_{cured}}{Δ {H}_{uncured}} \times 100$$

Where: ΔH_{uncured}=exothermic reaction peak area of an uncured resin
ΔH_{cured}=exothermic reaction peak area of an cured resin

The epoxy resin composition comprising component (A) also has a room temperature flexural modulus, when cured, of at least 4.5 GPa. If the room temperature modulus is less than 4.5 GPa, the FRP material obtained will have low compression strength. The flexural modulus of the cured epoxy resin can be determined by 3-point bending test in accordance with ASTM D 7264 using an Instron® Universal Testing Machine.

In accordance with certain embodiments, the epoxy resin composition also comprises component (B) wherein component (B) comprises an epoxy resin other than component (A) (i.e., an epoxy resin not in conformance with Formula (1)) or more than one epoxy resin other than component (A), to improve the cross linking, flexural strength, elongation, and processability. If present, such epoxy resins other than component (A) are present in a total amount representing at most 80 phr per 100 phr of total epoxy resin. Although the amount of component (B) may be zero, in certain embodiments the epoxy, resin composition is comprised of at least 5 phr or at least 10 phr in total of epoxy resin(s) other than component (A) per 100 phr of total epoxy resin. It is believed that an epoxy resin composition with very high flexural modulus tends to be very brittle and provides very low tensile strength and fracture toughness. In the present embodiments, an epoxy resin composition comprising component (B) epoxy can further enhance the strain to failure of the epoxy resin composition and improves the fracture toughness of the epoxy resin composition once it has been cured. These epoxy resins (epoxies) may be prepared from precursors such as amines (e.g., epoxy resins prepared using diamines and compounds containing at least one amine group and at least one hydroxyl group such as tetraglycidyl diaminodiphenyl methane, triglycidyl-p-aminophenol, triglycidyl-m-aminophenol, triglycidyl aminocresol and tetraglycidyl xylylenediamine and halogen-substituted products, alkynol-substituted products, hydrogenated products thereof and so on), phenols (e.g., bisphenol A epoxy resins, bisphenol F epoxy resins, bisphenol S epoxy resins, bisphenol R epoxy resins, phenol-novolac epoxy resins, cresol-novolac epoxy resins, resorcinol epoxy resins and triphenylmethane epoxy resins), dicyclopentadiene epoxy resins, naphthalene epoxy resins, epoxy resins having a biphenyl skeleton, isocyanate-modified epoxy resins, epoxy resins having a fluorene skeleton, and compounds having a carbon-carbon double bond (e.g., alicyclic epoxy resins). It should be noted that the epoxy resins suitable for use in component (B) are not restricted to the examples above. Halogenated epoxy resins prepared by halogenating these epoxy resins can also be used. Furthermore, mixtures of two or more of these epoxy resins, and compounds having one epoxy group or monoepoxy compounds such as glycidylaniline, glycidyl toluidine or other glycidylamines (particularly glycidylaromatic amines) can be employed in the formulation of the epoxy resin composition.

Some examples of commercially available epoxy resin products suitable for use as component (B) include: amine-based epoxy resins such as YH434L (manufactured by Nippon Steel Chemical Co., Ltd.), “jER (registered trademark)” 604 (manufactured by Mitsubishi Chemical Corporation)”, “Sumiepoxy (registered trademark)” ELM434 and, ELM100 (manufactured by Sumitomo Chemical Co., Ltd.), “Araldite (registered trademark)” MY9655T, MY0720, MY0721, MY0722, MY0500, MY0510, MY0600, and MY0610 (manufactured by Huntsman Advanced Materials), “jER (registered trademark)” 630 (manufactured by Mitsubishi Chemical Corporation), TETRAD-X and TETRAD-C (manufactured by Mitsubishi Gas Chemical Company, Inc.); bisphenol A epoxy resins such as “jER (registered trademark)” 825, 828, 834, 1001, 1002, 1003, 1003F, 1004, 1004AF, 1005F, 1006FS, 1007, 1009 and 1010 (manufactured by Mitsubishi Chemical Corporation), “Tactix (registered trademark)” 123 (manufactured by Huntsman Advanced Materials); brominated bisphenol A epoxy resins such as “jER (registered trademark)” 505, 5050, 5051, 5054 and 5057 (manufactured by Mitsubishi Chemical Corporation); hydrogenated bisphenol A epoxy resins such as ST5080, ST4000D, ST4100D, and ST5100 (manufactured by Nippon Steel Chemical Co., Ltd.); bisphenol F epoxy resins such as “jER (registered trademark)” 806, 807, 4002P, 4004P, 4007P, 4009P and 4010P (manufactured by Mitsubishi Chemical Corporation), and “Epotohto (registered trademark)” YDF2001 and YDF2004 (manufactured by Nippon Steel Chemical Co., Ltd.); tetramethyl-bisphenol F epoxy resins such as YSLV-80XY (manufactured by Nippon Steel Chemical Co., Ltd.); bisphenol S epoxy resins such as “Epiclon (registered trademark)” EXA-1514 (manufactured by DIC Corporation); phenol-novolac epoxy resins such as “jER (registered trademark)” 152 and 154 (manufactured by Mitsubishi Chemical Corporation), and “Epiclon (registered trademark)” N-740, N-770, and N-775 (manufactured by DIC Corporation); cresol-novolac epoxy resins such as “Epiclon (registered trademark)” N-660, N-665, N-670, N-673, and N-695 (manufactured by DIC Corporation), and EOCN-1020, EOCN-1025 and EOCN-1045 (manufactured by Nippon Kayaku Co., Ltd,); resorcinol epoxy resins such as “Denacol (registered trademark)” EX-201 (manufactured by Nagase ChemteX Corporation); naphthalene epoxy resins include “Epiclon (registered trademark)” HP-4700, HP-4710, HP-4770, EXA-4750, EXA-4701, EXA-7240, HP-5000L, HP-4032, and HP-4032D (manufactured by DIC Corporation), NC-7000L and NC-7300L (manufactured by Nippon Kayaku Co., Ltd.), ESN-175 and ESN-375 (manufactured by Tohto Kasei Epoxy Co., Ltd.), “Araldite (registered trademark)” MY 0816 (manufactured by Huntsman Advanced Materials); triphenylmethane epoxy resins such as “jER (registered trademark)” 1032S50 (manufactured by Mitsubishi Chemical Corporation), “Tactix (registered trademark)” 742 (manufactured by Huntsman Advanced Materials) and EPPN-501H (which are manufactured by Nippon Kayaku Co., Ltd.); dicyclopentadiene epoxy resins include “Epiclon (registered trademark)” HP-7200, HP7200L, HP-7200H and HP-7200HH (manufactured by DIC CORPORATION), “Tactix (registered trademark)” 556 (manufactured by Huntsman Advanced Materials), and XD-1000-1L and XD-1000-2L (manufactured by Nippon Kayaku Co., Ltd.); epoxy resins having a biphenyl skeleton such as “jER (registered trademark)” YX4000H, YX4000 and YL6616 (manufactured by Mitsubishi Chemical Corporation), and NC-3000 (manufactured by Nippon Kayaku Co., Ltd.); isocyanate-modified epoxy resins such as AER4152 (manufactured by Asahi Kasei Epoxy Co., Ltd.) and ACR1348 (manufactured by ADEKA Corporation) each of which has an oxazolidone ring; epoxy resins having a fluorene skeleton such as PG-100, CG-200 and EG-200 (manufactured by Osaka Gas Chemicals Co., Ltd and LME10169 (manufactured by Huntsman Advanced Materials); glycidylanilines such as GAN (manufactured by Nippon Kayaku Co., Ltd.), glycidyl toluidines such as GOT (manufactured by Nippon Kayaku Co., Ltd.), and epoxy resins having tert-butyl catechol such as “Epiclon (registered trademark)” HP-820 (manufactured by DIC Corporation). Furthermore, more than one of these epoxies may be used in combination as component (B).

In some embodiments of the invention, the abovementioned component (B) may comprise component (B1) and component (B2) which are epoxy resins which are different from each other, wherein component (B1) is an epoxy resin having more than two epoxy-functional groups per molecule and component (B2) is an epoxy resin different from component (B1) and having less than three epoxy-functional groups per molecule. Without wishing to be bound by theory, it is believed that the component (B1) epoxy resin provides high cross linking and high strength once the composition has been cured. It is also believed that a component (B2) epoxy resin provides high elongation to the cured epoxy resin composition and a low viscosity resin for handleability and tackiness. The “handleability” refers to the ability to easily handle and process the uncured fiber reinforced plastic.

The amount of component (B1) may be at most 80 phr per 100 phr of total epoxy resin. If the amount is greater than 80 phr, the epoxy resin composition may have low flexural modulus and the FRP material obtained may have low compression strength.

In some embodiments, component (B2) epoxy resin may have an average epoxy equivalent weight (EEW) of less than 205 g/eq to achieve high elongation. Examples of commercially available products suitable for use as component (B2) having an average EEW of less than 205 g/eq include: bisphenol A epoxy resins such as “jER (registered trademark)” 825, 828 and 834 (manufactured by Mitsubishi Chemical Corporation), “Tactix (registered trademark)” 123 (manufactured by Huntsman Advanced Materials); bisphenol F epoxy resins such as “Epiclon (registered trademark)” 830 (manufactured by DIC Corporation), “jER (registered trademark)” YL983U, 806 and 807 (manufactured by Mitsubishi Chemical Corporation); and naphthalene epoxy resins such as “Epiclon (registered trademark)” HP-5000L, HP-4032, and HP4032D (manufactured by DIC Corporation), and “Araldite (registered trademark)” MY 0816 (manufactured by Huntsman Advanced Materials), etc.

In other embodiments, component (B2) may have an average epoxy equivalent weight (EEW) of less than 170 g/eq to achieve even higher elongation. Additionally these epoxies can provide lower resin viscosity for handleability, processability, and tackiness. Examples of commercially available products suitable for component (B2) having an average epoxy equivalent weight (EEW) of less than 170 g/eq include: GAN (manufactured by Nippon Kayaku Co., Ltd.), TOREP® PG01 (manufactured by Toray Fine Chemicals Co., Ltd.), and cycloaliphatic epoxy resins such as “Celloxide (registered trademark)” 2021P, 8000, 8100, and 8200 (manufactured by Daicel Chemical Industries).

The amount of component (B2) may be at most 30 phr per 100 phr of total epoxy resin. If the amount is greater than 30 phr, the epoxy resin composition may have low heat resistance and the FRP material obtained may have low compression strength.

The viscosity of the epoxy resin composition at 40° C. may be between 1×10³ and 3×10⁴ Pa·s, in order to achieve both handleability and processability of the uncured FRP while maintaining the mechanical properties of the cured FRP. If the viscosity at 40° C. is too low, the handleability may be compromised because the tack may be too high. If the viscosity at 40° C. is too high, the moldability of the uncured FRP may be unsatisfactory because the tack may be too low. The viscosity of the epoxy resin composition was measured using a dynamic viscoelasticity measuring device (ARES, manufactured by TA Instruments) using parallel plates with a diameter of 40 mm while increasing the temperature at a rate of 2° C./min, with a strain of 10%, frequency of 0.5 Hz, and plate interval of 1 mm, from 40° C. to 150° C. The viscosity of the epoxy resin composition may be adjusted and controlled as may be desired by selecting particular components for use in the composition. In particular, the types and relative proportions of the epoxy resins present as components (A), (B1) and (B2) may be varied as needed to adjust the viscosity of the overall composition. For example, a component (B2) having a relatively low viscosity at 40° C. may be introduced for the purpose of reducing the viscosity of an epoxy resin composition that, due to the other components present, would otherwise have a viscosity at 40° C. that is higher than would be preferred.

As a curing agent, an amine-based curing agent (or a combination of different amine-based curing agents) is suitable for curing the epoxy resin composition. The amine-based curing agent is a compound that contains at least one nitrogen atom in the molecule (i.e., it is an amine-containing curing agent) and is capable of reacting with epoxy groups in the epoxy resins for curing. The nitrogen atom(s) may be in the form of primary and/or secondary amino groups. Without wishing to be bound by theory, it is believed that the amine-based curing agents utilized in the present embodiment provide high heat resistance and storage stability.

In some of the embodiments, component (C) comprises at least one amine-based curing agent. One suitable type of amine-based curing agent for component (C) is a diaminodiphenyl sulfone. Specific illustrative examples of suitable diaminodiphenyl sulfones include, but are not limited to, 4,4′-diaminodiphenyl sulfone (4,4′-DDS) and 3,3′-diaminodiphenyl sulfone (3,3′-DDS) and combinations thereof. In certain embodiments of the invention, component (C) consists essentially of or consists of one or more diaminodiphenyl sulfones. In such embodiments, diaminodiphenyl sulfone is the only type of curing agent present in the epoxy resin composition or constitutes at least 90%, at least 95%, or at least 99% by weight of the entire amount of curing agent.

In other embodiments, component (C) can be a combination of two or more amine-based curing agents. An example of a suitable combination of amine-based curing agents is the combination of a diaminodiphenyl sulfone and dicyandiamide. In certain embodiments of the invention, component (C) consists essentially of or consists of one or more diaminodiphenyl sulfones and dicyandiamide. In such embodiments, diaminodiphenyl sulfone and dicyandiamide are the only types of curing agent present in the epoxy resin composition or constitute at least 90%, at least 95%, or at least 99% by weight of the entire amount of curing agent.

When using diaminodiphenyl sulfone alone as a curing agent, the amount of component (C) may be in the range of 10 to 30 phr per 100 phr of total epoxy resin. If the amount is less than 10 phr, the degree of cure may be insufficient and the mechanical properties of FRP material obtained may be impaired. If the amount is greater than 30 phr, the degree of cure may be insufficient. Due to the excess unreacted amine curing agent, the mechanical properties of the FRP material obtained may also be adversely affected.

When using a combination of dicyandiamide and diaminodiphenyl sulfone as a curing agent, the amount of dicyandiamide may be up to 7 phr per 100 phr of total epoxy resin and the amount of diaminodiphenyl sulfone may be in the range of 5 to 30 phr per 100 phr of total epoxy resin. If the amount of dicyandiamine is greater than 7 phr, the degree of cure may be insufficient and the mechanical properties of FRP material obtained may be impaired. If the amount of diaminodiphenyl sulfone is less than 5 phr, the heat resistance and mechanical properties of the FRP material obtained may be impaired. If the amount of diaminodiphenyl sulfone is greater than 30 phr, the viscosity of the epoxy resin composition may become too high; the processing and moldability of the uncured FRP material may also be adversely affected.

In certain embodiments of the invention, the relative amounts of curing agent and epoxy resin in the epoxy resin composition are selected such that there is a significant molar excess of epoxy groups relative to active hydrogens. There are a total of seven active hydrogens in dicyandiamine and a total of four active hydrogens in diaminodiphenyl sulfone curing agents. For example, components (A), (B), and (C) may be present in amounts effective to provide a molar ratio of active hydrogens:epoxy groups of from 0.2:1 to 0.6:1 when component (C) is diaminodiphenyl sulfone alone or from 0.2:1 to 0.9:1 when component (C) is a combination of dicyandiamide and diaminodiphenyl sulfone. Formulations having a molar ratio lower than 0.2:1 will have low heat resistance and reduced properties, whereas formulations having a molar ratio higher than the upper limits of the aforementioned ranges will have lower reactivity and may not reach a high degree of cure at lower curing temperatures. In particular, it has been discovered that it is challenging to attain a degree of cure of at least 90% after heating the epoxy resin composition at 132° C. for 2 hours, if the active hydrogens:epoxy groups molar ratio in the epoxy resin composition is higher than the upper limits of the aforementioned ranges.

Examples of commercially available products suitable for use as component (C) include DICY-7 and DICY-15 (manufactured by Mitsubishi Chemical Corporation) and “Dyhard (registered trademark)” 100S (manufactured by AlzChem Trostberg GmbH), “Aradur (registered trademark)” 9664-1 and 9791-1 (manufactured by Huntsman Advanced Materials). A micronized grade of dicyandiamide is utilized in one embodiment of the present invention. These curing agents may be supplied as a powder or can be employed in the form of a mixture with a liquid epoxy resin composition

In other embodiments, any curing agents other than the abovementioned component (C) may be added to the epoxy resin composition, as long as the effect of the Invention is not deteriorated. Examples of other curing agents include polyamides, aromatic amidoamines (e.g., aminobenzamides, aminobenzanilides, and aminobenzene sulfonamides), aromatic diamines (e.g., diamino diphenylmethane, and m-phenylenediamine), tertiary amines (e.g., N—N-dimethylaniline, N,N-dimethylbenzylamine, and 2,4,6-tris(dimethylaminomethyl) phenol), aminobenzoates (e.g., trimethylene glycol di-p-aminobenzoate and neopentyl glycol di-p-amino-benzoate), aliphatic amines (e.g., diethylenetriamine, triethylenetetramine, isophoronediamine, bis(amineomethyl) norbornane, bis(4-amino cyclohexyl)methane, dimer acid esters of polyethyleneimine), imidazole derivatives (e.g., 2-methylimidazole, 1-benzyl-2-methylimidazole, 2-ethyl-4-methylimidazole), carboxylic acid anhydrides (e.g., methylhexahydrophthalic anhydride), carboxylic acid hydrazides (e.g., adipic acid hydrazide, naphthalene carboxylic acid hydrazide), tetramethylguanidine, carboxylic acid amides, polyphenol compounds, polysulfides and mercaptans, and Lewis acids and bases (e.g., boron trifluoride ethylamine and tris-(diethylaminomethyl) phenol), etc. For example, in embodiments where component (C) consists of diaminodiphenylsulfone or dicyandiamide and diaminodiphenyl sulfone, the epoxy resin composition may optionally additionally contain one or more of the above-mentioned curing agents. However, in other embodiments, the epoxy resin composition does not contain any curing agent other than the aforementioned component (C).

Furthermore, a latent curing agent can be also be used since it makes the storage stability of the epoxy resin composition excellent. A latent curing agent is a curing agent capable of exhibiting activity owing to a phase change or chemical change, etc. caused by certain stimulation such as heat or light. As the latent curing agent, an amine adduct latent curing agent, microcapsule latent curing agent, as well as dicyandiamide derivatives, can be used. An amine adduct latent curing agent is a product having a high molecular weight that is insoluble in the epoxy resin composition at the storage temperature, obtained by reacting an active ingredient such as a compound having a primary, secondary or tertiary amine group or any of various imidazole derivatives with a compound capable of reacting with those compounds. A microcapsule latent curing agent is a product obtained by using a curing agent as a nucleus and covering the nucleus with a shell such as a high molecular weight substance, for example, an epoxy resin, polyurethane resin, polystyrene-based compound or polyimide, etc., or cyclodextrin, etc., to decrease the contact between the epoxy resin and the curing agent. A dicyandiamide derivative is obtained by combining dicyandiamide with any of various compounds. Also suitable for use as a latent curing agent is a product obtained by reaction with an epoxy resin and a product obtained by reaction with a vinyl compound or acrylic compound, etc.

Examples of commercially available products which are amine adduct latent curing agents include: “Amicure (registered Trademark)” PN-23, PN-H, PN-40, PN-50, PN-F, MY-24 and MY-H (manufactured by Ajinomoto Fine-Techno Co., Inc.), “Adeka Hardener (registered trademark)” EH-3293S, EH-3615S and EH-4070S (manufactured by Adeka Corporation). Examples of commercially available products of suitable microcapsule latent curing agents include “Novacure (registered trademark)” HX-3721 and HX-3722 (manufactured by Asahi Kasei Chemicals Corporation. Examples of commercially available products of suitable dicyandiamide derivatives include DICY-7 and DICY-15 (manufactured by Mitsubishi Chemical Corporation). Any of the abovementioned curing agents can be used more than two in combination, as long as the effect of the invention is not deteriorated.

It has been discovered that the epoxy resin composition must be used with at least one curing catalyst to accelerate curing of the epoxy resin composition, so that the capability of achieving a high degree of cure (e.g., at least 85% or at least 90%) at a relatively low temperature (e.g., 132° C.) within a short period of time (e.g., two hours) is achieved.

In accordance with the present invention, component (D) is the curing catalyst, wherein the curing catalyst is one or more urea-based compounds that can accelerate the reaction of epoxy resin with any curing agents and/or the self-polymerization of epoxy resin. Without wishing to be bound by theory, it is believed that the epoxy resin composition using urea-based compound as the curing catalyst has high storage stability and high heat resistance.

The amount of component (D) may be in the range of 1 to 8 phr per 100 phr of total epoxy resin. If the amount is less than 1 phr, the acceleration effect may be insufficient; the heat resistance of the FRP material obtained may be impaired. If the amount of component (D) is greater than 8 phr, the accelerating effect may be excessive, the storage stability of the epoxy resin composition and the mechanical properties of the cured FRP material obtained may be impaired.

As used herein, the term “urea-based compound” means a compound containing at least one urea group (NC(═O)N). In certain embodiments of the invention, one or more aromatic urea compounds are used as component (D). Suitable aromatic urea compounds for component (D) include compounds containing at least one urea group (NC(═O)N) and at least one aromatic group (e.g., phenyl, substituted phenyl, naphthyl, etc.). Illustrative examples of suitable aromatic ureas include: N,N-dimethyl-N′-(3,4-dichlorophenyl) urea, toluene bis(dimethylurea), 4,4′-methylene bis(phenyl dimethylurea), N-(4-chlorophenyl)-N,N-dimethyl urea and 3-phenyl-1,1-dimethylurea, and combinations thereof.

Examples of commercially available aromatic ureas suitable for use as component (D) include: DCMU99 (manufactured by Hodogaya Chemical Co., Ltd.), “Dyhard (registered trademark)” UR200, UR300, UR400, UR500, URAcc13 and URAcc57 (manufactured by AlzChem Trostberg GmbH.), and “Omicure (registered trademark)” U-24, U-24M, U-52 and U-94 (manufactured by CVC Thermoset Specialties). Among these, aromatic ureas having more than one urea group per molecule (e.g., aromatic ureas having two urea groups per molecule) may be used in order to attain particularly rapid curing properties.

Non-aromatic ureas may also be employed as component (D), including in combination with aromatic ureas. Examples of suitable non-aromatic ureas (i.e., ureas not containing any aromatic groups) include aliphatic substituted ureas, in particular aliphatic bis-substituted ureas such as the cycloaliphatic dimethyl urea sold under the name “Omicure (registered trademark)” U35 (manufactured by CVC Thermoset Specialties).

In other embodiments, any curing catalyst(s) other than the urea-based compounds may also be added, as long as the effect of the invention is not deteriorated. Examples of such additional types of curing catalysts include boron trifluoride piperidine, p-t-butylcatechol, sulfonate compounds (e.g., ethyl p-toluenesulfonate, isopropyl p-toluenesulfonate or methyl p-toluenesulfonate), tertiary amines and salts thereof, imidazoles and salts thereof, phosphorus curing accelerators, metal carboxylates and Lewis and Bronsted acids and salts thereof. Examples of commercially available imidazole compounds or derivatives thereof include 2MZ, 2PZ and 2E4MZ (manufactured by Shikoku Chemicals Corporation). Examples of suitable Lewis acid catalysts include complexes of a boron trihalide and a base, such as a boron trifluoride piperidine complex, boron trifluoride monoethyl amine complex, boron trifluoride triethanol amine complex, or boron trichloride octyl amine complex. Any two or more of the abovementioned curing catalysts can be used in combination as long as the effect of the invention is not deteriorated.

The epoxy resin composition comprising the abovementioned components (A)-(D) may have a Tg (glass transition temperature) of at least 130° C. when fully cured. Said “fully cured” epoxy resin is a cured epoxy resin where the degree of cure degree is 85% or more after heating at 132° C. for 2 hours. If the Tg is less than 130° C., the FRP material may have low compression strength.

In certain embodiments, the cure profile is not particularly limited, as long as the effect of the invention is not deteriorated. If a higher Tg is desired, the epoxy resin composition can be cured at higher temperature. For example, the epoxy resin composition may have a Tg of 155° C. when the composition is cured at 180° C. for 2 hours. The Tg of a cured epoxy resin can be determined by using a torsional Dynamic Mechanical Analyzer (ARES, manufactured by TA Instruments).

In certain embodiments, the epoxy resin composition comprising the abovementioned components (A)-(D) may exhibit an increase in viscosity (as measured at 65° C.) of less than 2 times the starting viscosity when held at 65° C. for 2 hours. If the viscosity increase is less than 2 times, the resin composition may be considered as stable. If the viscosity increase is more than 2 times, the resin composition may be considered as unstable and the shelf-life may be shortened. The viscosity increase of the resin may be measured by setting the parameters of a dynamic viscoelasticity measuring device (ARES, manufactured by TA instruments) per the same method for viscosity measurement and holding at desired temperature for certain amount of time, in this case, 65° C. for 2 hours. The viscosity increase is calculated using the equation below:

$$viscosity increase = \frac{{η}_{final}}{{η}_{initial}}$$

ηᵢₙᵢₜᵢₐₗ is the initial viscosity of the resin at 65° C.
η_{final} is the final viscosity of the resin at 65° C. after 2 hours

Thermoplastic resin may be included in the epoxy resin composition, as long as the effect of the invention is not deteriorated. For example, the epoxy resin composition may contain at least 1 phr or at least 5 phr thermoplastic resin and/or not more than 30 phr or not more than 25 phr or not more than 20 phr thermoplastic resin per 100 phr of total epoxy resin. Without wishing to be bound by theory, it is believed that thermoplastic resins provide maximum fracture toughness and impact resistance to the cured epoxy resin composition. Such thermoplastic resins include, but are not limited to, elastomers, branched polymers, hyperbranched polymers, dendrimers, rubbery polymers, rubbery copolymers, and block copolymers, and core-shell particles, with or without surface modification or functionalization. Examples of suitable thermoplastic resins include thermoplastic resins that are soluble in an epoxy resin and organic particles such as rubber particles and thermoplastic resin particles. As the thermoplastic resin that is soluble in an epoxy resin, a thermoplastic resin having a hydrogen-binding functional group, which may have an effect of improving the adhesion between a cured epoxy resin and a reinforcing fiber, may be used. Examples of thermoplastic resins which are soluble in an epoxy resin and have hydrogen-binding functional groups include thermoplastic resins having one or more alcoholic hydroxy groups, thermoplastic resins having one or more amide bonds, and thermoplastic resins having one or more sulfonyl groups. Furthermore, the thermoplastic resin can be crystalline or amorphous.

Examples of thermoplastic resins having hydroxyl groups include polyvinyl acetal resins such as polyvinyl formal and polyvinyl butyral, polyvinyl alcohols and phenoxy resins. Examples of thermoplastic resins having amide bonds include polyamide, polyimide and polyvinyl pyrrolidone. An example of a thermoplastic resin having one or more sulfonyl groups is polysulfone. The polyamide, the polyimide and the polysulfone may have a functional group such as an ether bond and a carbonyl group in the main chain thereof. The polyamide may have a substituent on a nitrogen atom in the amide group.

Examples of commercially available thermoplastic resins soluble in an epoxy resin and having a hydrogen-binding functional group include: polyvinyl acetal resins such as “Denkabutyral (registered trademark)” and “Denkaformal (registered trademark)” (manufactured by Denki Kagaku Kogyo Kabushiki Kaisha) and “Vinylec (registered trademark)” (manufactured by JNC Corporation); phenoxy resins such as “UCAR (registered trademark)” PKHP (manufactured by Union Carbide Corporation); polyamide resins such as “Macromelt (registered trademark)” (manufactured by Henkel-Hakusui Corporation) and “Amilan (registered trademark)” CM4000 (manufactured by Toray Industries Inc.); polyimides such as “Ultem (registered trademark)” 1000P (manufactured by Sabic Innovative Plastics) and “Matrimid (registered trademark)” 5218 (manufactured by Huntsman Advanced Materials); polysulfones such as “SumikaExcel (registered trademark)” PES5003P (manufactured by Sumitomo Chemical Co., Ltd.), “UDEL (registered trademark)” (manufactured by Solvay Advanced Polymers Kabushiki Kaisha), and “Virantage (registered trademark) VW-10700RFP (manufactured by Solvay Plastics); and polyvinyl pyrrolidone such as “Luviskol (registered trademark)” (manufactured by BASF Japan Ltd.). Suitable polyethersulfones, for example, may have a number average molecular weight of from about 10,000 to about 75,000 g/mol.

For certain embodiments, any type(s) of additive(s) may be added, as long as the effect of the present invention is not deteriorated. Rubber particles may be added. As for the rubber particles, crosslinked rubber particles and core-shell rubber particles produced by the graft polymerization of different polymers on the surfaces of crosslinked rubber particles may be used, from the viewpoint of handling properties.

Examples of commercially available crosslinked rubber particles include FX501P (manufactured by Japan Synthetic Rubber Corporation), which comprises a crosslinked product of a carboxyl-modified butadiene-acrylonitrile copolymer, and CX-MN series (manufactured by Nippon Shokubai Co., Ltd.) and YR-500 series (manufactured by Nippon Steel Chemical Co., Ltd.), each of which comprises acrylic rubber microparticles.

Examples of commercially available core-shell rubber particle products include “Paraloid (registered trademark)” EXL-2655 (manufactured by Kureha Corporation), which comprises a butadiene-alkyl methacrylate-styrene copolymer, “Staphyloid (registered trademark)” AC-3355 and TR-2122 (manufactured by Takeda Pharmaceutical Co., Ltd.), each of which comprises an acrylic acid ester-methacrylic acid ester copolymer, “PARALOID (registered trademark)” EXL-2611 and EXL-3387 (manufactured by Rohm & Haas) each of which comprises a butyl acrylate-methyl methacrylate copolymer, and “Kane Ace (registered trademark)” MX series (manufactured by Kaneka Corporation).

The acrylic resin has high incompatibility with an epoxy resin, and therefore may be used suitably for controlling viscoelasticity. Examples of commercially available acrylic resin products include “Dianal (registered trademark)” BR series (manufactured by Mitsubishi Rayon Co., Ltd.), “Matsumoto Microsphere (registered trademark)” M, M100 and M500 (manufactured by Matsumoto Yushi-Seiyaku Co., Ltd.), and “Nanostrength (registered trademark)” E40F, M22N and M52N (manufactured by Arkema).

As for the thermoplastic resin particles, polyamide particles and polyimide particles may be used. Polyamide particles are most preferable for greatly increasing the impact resistance of the cured epoxy resin composition due to their excellent toughness. Among the polyamides, nylon 12, nylon 11, nylon 6, nylon 6/12 copolymer, and a nylon (semi-IPN nylon) modified to have a semi-IPN (interpenetrating polymer network) with an epoxy compound as disclosed in Example 1 of Japanese Patent Application Laid-open No. 1-104624 impart particularly good adhesive strength in combination with the epoxy resin. Examples of suitable commercially available polyamide particles include SP-500 (manufactured by Toray Industries Inc.) and “Orgasol (registered trademark)” (manufactured by Arkema), “Grilamid (registered trademark)” TR-55 (manufactured by EMS-Grivory), and “Trogamid (registered trademark)” CX (manufactured by Evonik).

Furthermore, any type of inorganic particle such as clay may be included in the epoxy resin composition, as long as the effect of the present invention is not deteriorated. Examples of suitable inorganic particles include metallic oxide particles, metallic particles and mineral particles. The inorganic particles may be used to improve one or more functions of the cured epoxy resin composition and to impart one or more functions to the cured epoxy resin composition. Examples of such functions include surface hardness, anti-blocking property, heat resistance, barrier property, conductivity, antistatic property, electromagnetic wave absorption, UV shield, toughness, impact resistance, and low coefficient of linear thermal expansion. Examples of other suitable inorganic materials include aluminum hydroxide, magnesium hydroxide, glass beads, glass flakes and glass balloons.

Examples of suitable metallic oxides include silicon oxide, titanium oxide, zirconium oxide, zinc oxide, tin oxide, indium oxide, aluminum oxide, antimony oxide, cerium oxide, magnesium oxide, iron oxide, tin-doped indium oxide (ITO), antimony-doped tin oxide and fluorine-doped tin oxide. Examples of suitable metals include gold, silver, copper, aluminum, nickel, iron, zinc and stainless. Examples of suitable minerals include montmorillonite, talc, mica, boehmite, kaoline, smectite, xonotlite, vermiculite and sericite.

Examples of other suitable carbonaceous materials include carbon black, acetylene black, Ketjen black, carbon nanotubes, graphenes, carbon nanofibers, carbon nanobeads, fullerenes, etc.

Any size of inorganic particles may be used; for example, the inorganic particles may have a size which is in the range of 1 nm to 10 μm. Any shape inorganic particles may be used; for example, the inorganic particles may be spherical, needles, plates, balloons or hollow in shape. The inorganic particles may be just used as powder or used as a dispersion in a solvent-like sol or colloid. Furthermore, the surface of the inorganic particle may be treated by a coupling agent to improve the dispersibility and the interfacial affinity with the epoxy resin.

In certain embodiments, the epoxy resin composition may contain one or more other materials in addition to the abovementioned materials, as long as the effect of the present invention is not deteriorated. Examples of other materials include mold release agents, surface treatment agents, flame retardants, antibacterial agents, leveling agents, antifoaming agents, thixotropic agents, heat stabilizers, light stabilizers, UV absorbers, pigments, coupling agents and metal alkoxides.

Particularly advantageous epoxy resin compositions in accordance with the present invention include epoxy resin compositions which comprise, consist essentially of, or consist of:
(A) at least 20 phr per 100 phr of total epoxy resin of at least one tetrafunctional amine-based epoxy selected from the group consisting of tetraglycidyl diaminodiphenyl ethers, tetraglycidyl diaminodiphenyl sulfones, and combinations thereof;
(B) optionally, up to 80 phr per 100 phr of total epoxy resin of one or more epoxy resins selected from the group consisting of tetraglycidyl diaminodiphenyl methanes, bisphenol A epoxy resins, diglycidyl phenoxyaniline, cycloaliphatic epoxy resins, and combinations thereof;
(C) at least one amine-based curing agent selected from the group consisting of dicyandiamide, diaminodiphenyl sulfones, and combinations thereof, wherein components (A), (B) and (C) are each present in amounts effective to provide a molar ratio of active hydrogens:epoxy groups of from 0.2:1 to 0.9:1; and
(D) at least one urea-based catalyst selected from the group consisting of N,N-dimethyl-N′-(3, 4-dichlorophenyl) urea, toluene bis(dimethylurea), 4,4′-methylene bis(phenyl dimethylurea), N-(4-chlorophenyl) N,N-dimethyl urea, 3-phenyl-1,1-dimethylurea and combinations thereof in an amount of from 1 to 8 phr per 100 phr of total epoxy resin;
(E) at least one thermoplastic resin selected from the group consisting of polyethersulfones in an amount of from 5 to 30 phr per 100 phr of total epoxy resin; and
(F) optionally, inorganic particles.

The components of the epoxy resin composition may be mixed in a kneader, planetary mixer, triple roll mill, twin screw extruder, and the like. The epoxy resins and any thermoplastic resins, excluding curing agents and catalysts, are added in the selected equipment. The mixture is then heated to a temperature in the range of 130 to 180° C. while being stirred so as to uniformly dissolve the epoxy resins. After this, the mixture is cooled down to a temperature of no more than 100° C., while being stirred, followed by the addition of the curing agents and catalysts and kneading to disperse those components. This method may be used to provide an epoxy resin composition with excellent storage stability.

There are no specific limitations or restrictions on the type of a reinforcing fiber that can be used, as long as the effects of the invention are not deteriorated. Examples include glass fibers, carbon fibers, and graphite fibers such as S glass, S-1 glass, S-2 glass, S-3 glass, E-glass, and L-glass fibers, organic fibers such as aramid fibers, boron fibers, metal fibers such as alumina fibers, silicon carbide fibers, tungsten carbide fibers, and natural/bio fibers. Particularly, the use of carbon fiber may provide cured FRP materials which have exceptionally high strength and stiffness and which are lightweight as well. Examples of suitable carbon fibers are those from Toray Industries having a standard modulus of about 200-250 GPa (Torayca® T300, T300J, T400H, T600S, T700S, T700G), an intermediate modulus of about 250-300 GPa (Torayca® T800H, T800S, T1000G, M305, M30G), or a high modulus of greater than 300 GPa (Torayca® M40, M35J, M40J, M46J, M50J, M553, M60J). Among these carbon fibers, one with standard modulus, strength of 4.9 GPa or higher and elongation of 2.1% or higher is used in the examples.

The form and the arrangement of a layer of reinforcing fibers used are not specifically limited. Any of the forms and spatial arrangements of the reinforcing fibers known in the art such as long fibers in a direction, chopped fibers in random orientation, single tow, narrow tow, woven fabrics, mats, knitted fabrics, and braids may be employed. The term “long fiber” as used herein refers to a single fiber that is substantially continuous over 10 mm or longer or a fiber bundle comprising the single fibers. The term “short fibers” as used herein refers to a fiber bundle comprising fibers that are cut into lengths of shorter than 10 mm. Particularly in the end use applications for which high specific strength and high specific elastic modulus are desired, a form wherein a reinforcing fiber bundle is arranged in one direction may be most suitable. From the viewpoint of ease of handling, a cloth-like (woven fabric) form is also suitable for the present invention.

The FRP materials of the present invention may be manufactured using methods such as the prepreg lamination and molding method, resin transfer molding method, resin film infusion method, hand lay-up method, sheet molding compound method, filament winding method and pultrusion method, though no specific limitations or restrictions apply in this respect.

The resin transfer molding method is a method in which a reinforcing fiber base material is directly impregnated with a liquid thermosetting resin composition and cured. Since this method does not involve an intermediate product, such as a prepreg, it has great potential for molding cost reduction and is advantageously used for the manufacture of structural materials for spacecraft, aircraft, rail vehicles, automobiles, marine vessels and so on.

The prepreg lamination and molding method is a method in which a prepreg or prepregs, produced by impregnating a reinforcing fiber base material with a thermosetting resin composition, is/are formed and/or laminated, followed by the curing of the resin through the application of heat and pressure to the formed and/or laminated prepreg/prepregs to obtain an FRP material.

The filament winding method is a method in which one to several tens of reinforcing fiber rovings are drawn together in one direction and impregnated with a thermosetting resin composition as they are wrapped around a rotating metal core (mandrel) under tension at a predetermined angle. After the wraps of rovings reach a predetermined thickness, it is cured and then the metal core is removed.

The pultrusion method is a method in which reinforcing fibers are continuously passed through an impregnating tank filled with a liquid thermosetting resin composition to impregnate them with the thermosetting resin composition, followed by processing through a squeeze die and heating die for molding and curing, by continuously drawing the impregnated reinforcing fibers using a tensile machine. Since this method offers the advantage of continuously molding FRP materials, it is used for the manufacture of FRP materials for fishing rods, rods, pipes, sheets, antennas, architectural structures, and so on. Of these methods, the prepreg lamination and molding method may be used to give excellent stiffness and strength to the FRP materials obtained.

Prepregs may contain the epoxy resin composition and reinforcing fibers. Such prepregs may be obtained by impregnating a reinforcing fiber base material with an epoxy resin composition of the present invention. Impregnation methods include the wet method and hot-melt method (dry method).

The wet method is a method in which reinforcing fibers are first immersed in a solution of an epoxy resin composition, created by dissolving the epoxy resin composition in a solvent, such as methyl ethyl ketone or methanol, and retrieved, followed by the removal of the solvent through evaporation via an oven, etc. to impregnate reinforcing fibers with the epoxy resin composition. The hot-melt method may be implemented by impregnating reinforcing fibers directly with an epoxy resin composition, made fluid by heating in advance, or by first coating a piece or pieces of release paper or the like with an epoxy resin composition for use as resin film and then placing a film over one or either side of reinforcing fibers as configured into a flat shape, followed by the application of heat and pressure to impregnate the reinforcing fibers with the resin. The hot-melt method may give a prepreg having virtually no residual solvent in it.

The prepreg may have a carbon fiber areal weight of between 40 to 350 g/m². If the carbon fiber areal weight is less than 40 g/m², there may be insufficient fiber content, and the FRP material may have low strength. If the carbon fiber areal weight is more than 350 g/m², the drapability of the prepreg may be impaired. The prepreg may also have a resin content of between 20 to 70 wt %. If the resin content is less than 20 wt %, the impregnation may be unsatisfactory, creating large number of voids. If the resin content is more than 70 wt %, the FRP mechanical properties will be impaired.

Appropriate heat and pressure may be used under the prepreg lamination and molding method, the press molding method, autoclave molding method, bagging molding method, wrapping tape method, internal pressure molding method, or the like.

The autoclave molding method is a method in which prepregs are laminated on a tool plate of a predetermined shape and then covered with bagging film, followed by curing, performed through the application of heat and pressure while air is drawn out of the laminate. It may allow precision control of the fiber orientation, as well as providing high-quality molded materials with excellent mechanical characteristics, due to a minimum void content. The pressure applied during the molding process may be 0.3 to 1.0 MPa, while the molding temperature may be in the 90 to 300° C. range (in one embodiment of the invention, in the range of 110° C. to 150° C., e.g., 120° C. to 140° C.).

The wrapping tape method is a method in which prepregs are wrapped around a mandrel or some other cored bar to form a tubular FRP material. This method may be used to produce golf shafts, fishing poles and other rod-shaped products. In more concrete terms, the method involves the wrapping of prepregs around a mandrel, wrapping of wrapping tape made of thermoplastic film over the prepregs under tension for the purpose of securing the prepregs and applying pressure to them. After curing of the resin through heating inside an oven, the cored bar is removed to obtain the tubular body. The tension used to wrap the wrapping tape may be 20 to 100 N. The curing temperature may be in the 80 to 300° C. range (in one embodiment of the invention, in the range of 110° C. to 150° C., e.g., 120° C. to 140° C.).

The internal pressure forming method is a method in which a preform obtained by wrapping prepregs around a thermoplastic resin tube or some other internal pressure applicator is set inside a metal mold, followed by the introduction of high pressure gas into the internal pressure applicator to apply pressure, accompanied by the simultaneous heating of the metal mold to mold the prepregs. This method may be used when forming objects with complex shapes, such as golf shafts, bats, and tennis or badminton rackets. The pressure applied during the molding process may be 0.1 to 2.0 MPa. The molding temperature may be between room temperature and 300° C. or in the 180 to 275° C. range (in one embodiment of the invention, in the range of 110° C. to 150° C., e.g., 120° C. to 140° C.).

The FRP materials that contain cured epoxy resin compositions obtained from epoxy resin compositions of the present invention and reinforcing fibers are advantageously used in general industrial applications, as well as aeronautics and space applications. The FRP materials may also be, used in other applications such as sports applications (e.g. golf shafts, fishing rods, tennis or badminton rackets, hockey sticks and ski poles) and structural materials for vehicles (e.g. automobiles, bicycles, marine vessels and rail vehicles, drive shafts, leaf springs, windmill blades, pressure vessels, flywheels, papermaking rollers, roofing materials, cables, and repair/reinforcement materials).

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

The present embodiments are now described in more detail by way of examples. The measurement of various properties was carried out using the methods described below. Those properties were, unless otherwise noted, measured under environmental conditions comprising a temperature of 23° C. and a relative humidity of 50%. The components used in the examples are as follows:

Tetraglycidyl diaminodiphenyl sulfone, TG3DAS (manufactured by Konishi Chemical Ind. Co., Ltd.) having an average epoxide equivalent weight (EEW) of 140 g/eq.

Tetraglycidyl diaminodiphenyl ether (4,4′-TGDDE), S-722 (manufactured by Synasia Fine Chemical Inc.) having an average epoxide equivalent weight (EEW) of 111 g/eq.

Tetraglycidyl diaminodiphenyl methane, “Araldite (registered trademark)” MY9655T (manufactured by Huntsman Advanced Materials) having an average epoxide equivalent weight (EEW) of 120 g/eq.

Bisphenol A epoxy resin, “Epon (registered trademark)” 828 (manufactured by Momentive Specialty Chemicals) having an average epoxide equivalent weight (EEW) of 185 g/eq.

Diglycidyl phenoxyaniline (TOREP® PG01) (manufactured by Toray Fine Chemical, Ltd.) having an average epoxide equivalent weight (EEW) of 167 g/eq.

Cycloaliphatic epoxy, “Celloxide (registered trademark)” 8000 (manufactured by Daicel Chemical Industries) having an average epoxide equivalent weight (EEW) of 101 g/eq.

Dicyandiamide, “Dyhard (registered trademark)” 100S (manufactured by AlzChem Trostberg GmbH).

4,4′-Diaminodiphenyl sulfone (4,4′-DDS), “Aradur (registered trademark)” 9664-1 (manufactured by Huntsman Advanced Materials).

3,3′-Diaminodiphenyl sulfone (3,3′-DDS), “Aradur (registered trademark)” 9791-1 (manufactured by Huntsman Advanced Materials).

2,4′-Toluene bisdimethylurea, “Omicure (registered trademark)” U-24M (manufactured by CVC Thermoset Specialties).

3-(3,4-Dichlorophenyl)-1,1-dimethyl urea, “Dyhard (registered trademark)” UR200 (manufactured by AlzChem Trostberg GmbH).

“Dyhard (registered trademark)” URAcc13 (manufactured by AlzChem Trostberg GmbH).

4,4-methylenediphenylene bisdimethylurea, “Dyhard (registered trademark)” UR400 (manufactured by AlzChem Trostberg GmbH).

Polyethersulfone with a terminal hydroxyl group, “Sumikaexcel (registered trademark)” PES5003P (manufactured by Sumitomo Chemical Co., Ltd.) having a number average molecular weight of 47,000 g/mol.

Polyethersulfone, “Virantage (registered trademark)” VW10700RFP polyethersulfone (manufactured by Solvay Advanced Polymers) having a number average molecular weight of 21,000 g/mol.

Plain Weave Carbon fiber, “Torayca (registered trademark)” T700S-12K-50C having a fiber filament count of 12,000, tensile strength of 4.9 GPa, tensile elasticity of 230 GPa, and tensile elongation of 2.1% (manufactured by Toray Industries Inc.).

### Methods

The following methods were used to prepare and measure the epoxy resin composition, the prepreg and the FRP material for each example.

### (1) Resin Mixing

A mixture was created by dissolving prescribed amounts of all the components other than the curing agent and curing accelerator (curing catalyst) in a mixer, and then prescribed amounts of the curing agent were mixed into the mixture along with prescribed amounts of the accelerator to obtain the epoxy resin composition.

### (2) Cured Profile

The cured epoxy resin composition was molded by the following method described in this section. After mixing, the epoxy resin composition prepared in (1) was injected into a mold set for a thickness of 2 mm using a 2 mm-thick “Teflon (registered trademark)” spacer. Then, the epoxy resin composition was heated at a rate of 1.7° C./min from room temperature to 132° C. and then kept for 2 hours at 132° C. to obtain 2 mm-thick cured epoxy resin composition plates.

### (3) Degree of Cure

In other embodiments of the present invention, the epoxy resin composition may be cured to have a certain degree of cure. The percent cure or degree of cure (DoC) of an epoxy resin composition can be determined using a Differential Scanning calorimeter (DSC) (Q200 with an RCS (mechanical refrigeration cooling system), manufactured by TA Instruments). The degree of cure is empirically determined by comparing the exothermic reaction peak area of an uncured resin (ΔH_{uncured}) against the residual exothermic reaction peak area of a cured resin (ΔH_{cured}), using a ramp rate of 10°/min. The uncured resin obtained in (1) was subjected to a dynamic scan with a heating rate of 10° C./min from −50° C. to a final temperature at which the exothermic reaction is completed and above which thermal degradation might occur. The cured epoxy resin composition obtained in (2) was subjected to a dynamic scan with a heating rate of 10° C./min from 50° C. to a final temperature at which the exothermic reaction is completed and above which thermal degradation might occur. Herein, the degree of cure can be calculated by the following formula:

$$Degree of Cure , DoC ( \% ) = \frac{Δ {H}_{uncured} - Δ {H}_{cured}}{Δ {H}_{uncured}} \times 100$$

Where: ΔH_{uncured}=exothermic reaction peak area of an uncured resin
ΔH_{cured}=exothermic reaction peak area of a cured resin

### (4) Glass Transition Temperature (Tg) of Cured Resin

In other embodiments of the present invention, the epoxy resin composition may have a certain Tg (glass transition temperature). The Tg may be determined using the following method. A specimen measuring 12 mm×50 mm is cut from a cured epoxy resin composition obtained in (2). The specimen is then subjected to measurement of Tg in 1.0 Hz Torsion Mode using a dynamic viscoelasticity measuring device (ARES, manufactured by TA Instruments) by heating it to the temperatures of 50° C. to 250° C. at a rate of 5° C./min in accordance with SACMA SRM 18R-94.

Tg was determined by finding the intersection between the tangent line of the glass region and the tangent line of the transition region from the glass region to the rubber region on the temperature-storage elasticity modulus curve, and the temperature at that intersection was considered to be the glass transition temperature (also called the G′ Tg).

### (5) Viscosity Measurement Method

In other embodiments of the present invention, the epoxy resin composition may have a certain viscosity at 40° C. In the present invention, “viscosity” refers to the complex viscoelastic modulus.

The viscosity of the epoxy resin composition was measured using a dynamic viscoelasticity measuring device (ARES, manufactured by TA Instruments) using parallel plates with a diameter of 40 mm while increasing the temperature at a rate of 2° C./min, with a strain of 10%, frequency of 0.5 Hz, and plate interval of 1 mm, from 40° C. to 150° C.

### (6) Viscosity Increase

The viscosity increase of the epoxy resin composition is measured by setting the parameters of a dynamic viscoelasticity measuring device (ARES, manufactured by TA instruments) per the same method for viscosity measurement and holding the desired temperature for certain amount of time, in this case, 65° C. for 2 hours. The viscosity increase is calculated using the equation below:

$$viscosity increase = \frac{{η}_{final}}{{η}_{initial}}$$

ηᵢₙᵢₜᵢₐₗ is the initial viscosity of the epoxy resin composition at 65° C.
η_{final} is the final viscosity of the epoxy resin composition at 65° C. after 2 hours

### (7) 3-Point Bending Test

In other embodiments of the present invention, the epoxy resin composition may have certain flexural properties. Flexural properties were measured in accordance with the following procedure. A specimen measuring 12.5 mm×60 mm was cut from the cured epoxy resin composition obtained in (2). Then, the specimen is processed in a 3-point bend flexural test in accordance with ASTM D7264 using an Instron® Universal Testing Machine. The test specimens are tested at room temperature to obtain the RTD flexural properties of the cured epoxy resin composition.

### (8) Open-Hole Compression Strength (OHC) for FRP

In some embodiments, the FRP laminate comprising the epoxy resin composition was prepared to test Open Hole Compression (OHC) strength. The prepreg was cut into 350 mm×350 mm samples. After layering 16 sheets of the fabric prepreg samples to produce a (+45°/0° Warp/−45°/90° Fill)_{2S} configuration laminate, vacuum bagging was carried out, and the laminate was cured at a rate of 1.7° C./min from room temperature to 132° C. under pressure of 0.59. MPa using an autoclave to obtain a quasi-isotropic FRP material. The cured laminate was cut into a rectangular shape with a length of 304.8 mm in the 0° Warp direction and a length of 38.1 mm in the 90° Fill direction, and a circular hole with a diameter of 6.35 mm was made in the center to produce a plate with a hole, thus obtaining the test specimen. This test specimen was then subjected to open-hole compression testing as prescribed in ASTM-D 6484 using an Instron Universal Testing Machine.

### Working Examples 1-19

The various amounts of the components used for each example are stated in Tables 1-4. The epoxy resin compositions shown in Tables 1-4 were produced in accordance with the method described in (1). The properties for each example are stated in Tables 1-4. These properties were achieved using the cure profile described in (2).

A prepreg comprising a reinforcing fiber impregnated with the epoxy resin composition was obtained by the following method. The epoxy resin composition obtained by method (1) was applied onto release paper using a knife coater to produce two sheets of 68.0 g/m² resin film. Next, the aforementioned two sheets of fabricated resin film were overlaid on both sides of plain weave carbon fibers (T700S-12K-50C) with a density of 1.8 g/cm² in the form of a sheet and the epoxy resin composition was impregnated using a roller temperature of 100° C. and a roller pressure of 0.07 MPa to produce a fabric prepreg with a carbon fiber areal weight of 190 g/m² and a resin content of 42 wt %. The FRP material was molded by the method described in (8). The OHC results for some of the embodiments are stated in Tables 1-4.

In comparison to comparative examples 1-14, the epoxy resin compositions in working examples 1-19 comprising the embodiments of the invention have significantly higher resin flexural modulus at RTD and high Tg with adequate degree of cure and thermal stability.

As the epoxy resin compositions in comparative examples 1-2 and 7 did not use a component (A) epoxy and were cured at 132° C. for 2 hours, the cured resins obtained had an inadequate resin flexural modulus. As a result, the fiber reinforced composite materials produced from the epoxy resin compositions had inadequate compression strength.

As the epoxy resin compositions in comparative examples 3-4 did not use a component (D) urea-based catalyst but used only amine-based cure agent and were cured at 132° C. for 2 hours, the cured resins obtained had an insufficient degree of cure. As a result, the cured resins and fiber reinforced composite materials obtained may have low mechanical characteristics.

As the epoxy resin composition in comparative example 5 used only urea-based catalyst as a component (D) and was cured at 132° C. for 2 hours, the cured resin obtained had insufficient degree of cure and the fiber reinforced composite materials obtained may have unbalanced mechanical characteristic.

As the epoxy resin composition in comparative example 6 used only one component (A) and was cured at 132° C. for 2 hours, the cured resin obtained had insufficient resin flexural modulus and the fiber reinforced composite materials obtained may have unbalanced mechanical characteristic. As opposed to comparative example 6, the working example 6 showed that the resin flexural modulus was regained as other epoxies were incorporated.

As the epoxy resin compositions in comparative examples 8 and 9 only used DICY as a component (C) and were cured at 132° C. for 2 hours, the cured resins obtained had insufficient degree of cure and the fiber reinforced composite materials obtained may have unbalanced mechanical characteristic.

As opposed to comparative examples 3-6, the working example 1 showed well-balanced resin properties between flexural modulus, Tg, and degree of cure.

As the epoxy resin compositions of working examples 3-4 showed that the best performance of resin properties could be achieved with diaminodiphenyl sulfone cure agent while the molar ratio of active hydrogen:epoxy groups is between 0.2 and 0.6. As the epoxy resin compositions in comparative examples 10-12 used a molar ratio of active hydrogen:epoxy groups of less than 0.2 or more than 0.7, the cured resin obtained had insufficient degree of cure due to insufficient curing agent or excess curing agent and the fiber reinforced composite materials obtained may have unbalanced mechanical characteristic.

The epoxy resin compositions of working examples 1-19 showed that the best performance of resin properties could also be achieved with the combination of diaminodiphenyl sulfone and dicyandiamide cure agents while the molar ratio of active hydrogen:epoxy groups is between 0.4 and 0.9.

TABLE 1
Comparative Examples

| | | | Unit | C.E. 1 | C.E. 2 | C.E. 3 | C.E. 4 | C.E. 5 | C.E. 6 | C.E. 7 | C.E. 8 |
|---|---|---|---|---|---|---|---|---|---|---|---|
| Epoxy | Component A | TG3DAS | phr | | | 100 | 100 | 100 | | | 80 |
| | | S-722 | | | | | | | 100 | | |
| | Component B | EPON ®828 | | 10 | 30 | | | | | 0 | 0 |
| | | Araldite ® MY9655T | | 90 | 70 | 0 | 0 | | 0 | 100 | 20 |
| | | TOREP ® PG01 | | | | | | | | | |
| | | Celloxide ®8000 | | | | | | | | | |
| Curing Agent | Component C | Dyhard ® 100S | | 3 | 3 | 3 | 0 | | 3 | 3 | 3 |
| | Component C | Aradur ® 9664-1 | | 10 | 10 | 0 | 10 | | | 10 | 0 |
| | | Aradur ® 9719-1 | | | | | | | 10 | | |
| Accelerator | Component D | Dyhard ® UR200 | | 4 | | | | | | | |
| (Catalyst) | | Dyhard ® UR400 | | | | | | | | | |
| | | Omicure ® U-24M | | | 5 | 0 | 0 | 6 | 5 | 5 | 5 |
| | | Dyhard ® URAcc13 | | | | | | | | | |
| Additive | Thermoplastic | SumikaExcel ® 5003P | | 10 | 10 | 10 | 10 | 10 | 10 | 10 | 10 |
| | | Virantage ® | | | | | | | | | |
| | | VW-10700RFP | | | | | | | | | |
| Active Hydrogen:Epoxy group Molar Ratio | | | | 0.51 | 0.55 | 0.35 | 0.23 | 0 | 0.45 | 0.49 | 0.34 |
| Epoxy Resin | Flexural Modulus | RTD | GPa | 4.1 | 3.7 | | | 4.6 | 4.2 | 4.2 | 4.7 |
| Properties | Tg | RTD | ° C. | 142 | 148 | | | 150 | | 150 | 146 |
| | Degree of Cure | | % | 95 | 91 | <50 | <50 | 85 | 97 | 95 | 87 |
| | Viscosity increase at 65° C. after 2 hours | | % | 1.0 | 1.3 | | | | | | |
| CFRP Properties | OHC Strength | RTD | ksi | 40 | 39 | | | | 40 | 40 | 41 |

TABLE 2
Comparative Examples

| | | | Unit | C.E. 9 | C.E. 10 | C.E. 11 | C.E. 12 | C.E. 13 | C.E. 14 |
|---|---|---|---|---|---|---|---|---|---|
| Epoxy | Component A | TG3DAS | phr | 100 | 100 | 100 | 100 | 100 | 100 |
| | | S-722 | | | | | | | |
| | Component B | EPON ®828 | | 0 | 0 | 0 | 0 | 0 | 0 |
| | | Araldite ® MY9655T | | | | | | | |
| | | TOREP ® PG01 | | | | | | | |
| | | Celloxide ®8000 | | | | | | | |
| Curing Agent | Component C | Dyhard ® 100S | | 8 | 0 | 0 | 0 | 3 | 4 |
| | Component C | Aradur ® 9664-1 | | 0 | | | | 10 | 6 |
| | | Aradur ® 9719-1 | | | 6 | 40 | 53 | | |
| Accelerator | Component D | Dyhard ® UR200 | | | | | | | |
| (Catalyst) | | Dyhard ® UR400 | | | | | | | |
| | | Omicure ® U-24M | | 5 | 5 | 5 | 5 | 9 | 5 |
| | | Dyhard ® URAcc13 | | | | | | | |
| 10 | Thermoplastic | SumikaExcel ® 5003P | | 10 | 10 | | 10 | 10 | |
| | | Virantage ® | | | | 10 | | | 8 |
| | | VW-10700RFP | | | | | | | |
| Active Hydrogen:Epoxy group Moiar Ratio | | | | 0.93 | 0.14 | 0.93 | 1.19 | 0.57 | 0.9 |
| Epoxy Resin | Flexural Modulus | RTD | GPa | 5.7 | 5.1 | 5.5 | 5.6 | 5.5 | 5.5 |
| Properties | Tg | RTD | ° C. | | 153 | 143 | 129 | 155 | |
| | Degree of Cure | | % | 78 | 88 | 85 | 83 | 93 | 81 |
| | Viscosity increase at 65° C. after 2 hours | | % | | | | | 2.1 | |
| CFRP Properties | OHC Strength | RTD | ksi | | 42 | | | | |

TABLE 3
Working Examples

| | | | | Ex. | Ex. | Ex. | Ex. | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|---|---|---|---|---|---|
| | | | Unit | 1 | 2 | 3 | 4 | 5 | 6 | 7 | 8 | 9 | 10 | 11 | 12 | 13 | 14 | 15 | 16 | 17 |
| Epoxy | Component A | TG3DAS | phr | 100 | 80 | 80 | 100 | 90 | 45 | | 70 | 70 | 50 | 30 | 30 | 30 | 30 | 30 | | 50 |
| | | S-722 | | | | | | | | 45 | | | | | | | | | 30 | 50 |
| | Component B | EPON ®828 | | | | | | 10 | 10 | 10 | | | | | | | | | | |
| | | Araldite ® | | | 20 | 20 | | | 45 | 45 | 30 | | 50 | 70 | 60 | 60 | 60 | 60 | 60 | |
| | | MY9655T | | | | | | | | | | | | | | | | | | |
| | | TOREP ® | | | | | | | | | | 30 | | | | | | | | |
| | | PG01 | | | | | | | | | | | | | | | | | | |
| | | Celloxide ® | | | | | | | | | | | | | 10 | 10 | 10 | 10 | 10 | |
| | | 8000 | | | | | | | | | | | | | | | | | | |
| Curing | Component C | Dyhard ® | | 3 | 5 | 0 | 0 | 3 | 3 | 3 | 3 | 3 | 3 | 3 | 3 | 3 | 3 | 3 | 3 | 3 |
| Agent | | 100S | | | | | | | | | | | | | | | | | | |
| | | Aradur ® | | 10 . | 15 | 10 | | 10 | 10 | 10 | 10 | | 10 | 10 | | | | | | 10 |
| | | 9664-1 | | | | | | | | | | | | | | | | | | |
| | | Aradur ® | | | | | 30 | | | | | 10 | | | 10 | 10 | 10 | 10 | 10 | |
| | | 9719-1 | | | | | | | | | | | | | | | | | | |
| Accelerat | Component D | Dyhard ® | | | | | | | | | | | | | | | | 3 | | |
| or | | UR200 | | | | | | | | | | | | | | | | | | |
| (Catalyst) | | Dyhard ® | | | | | | | | | | | | | | | 3 | | | |
| | | UR400 | | | | | | | | | | | | | | | | | | |
| | | Omicure ® | | 5 | 5 | 5 | 5 | 5 | 5 | 5 | 5 | 3 | 5 | 5 | | 3 | | | | 5 |
| | | U-24M | | | | | | | | | | | | | | | | | | |
| | | Dyhard ® | | | | | | | | | | | | | 3 | | | | 3 | |
| | | URACC13 | | | | | | | | | | | | | | | | | | |
| Additive | Thermo- | Sumika Excel ® | | | | 10 | | | | | 10 | | 10 | 10 | | | | | | |
| | plastic | 5003P | | | | | | | | | | | | | | | | | | |
| | | Virantage ® | | 10 | | | 10 | 14 | 12 | 12 | | 16 | | | 16 | 16 | 16 | 16 | 16 | 12 |
| | | VW-10700RFP | | | | | | | | | | | | | | | | | | |
| Active Hydrogen:Epoxy group Molar | | | | 0.58 | 0.89 | 0.22 | 0.68 | 0.59 | 0.55 | 0.49 | 0.55 | 0.61 | 0.53 | 0.51 | 0.50 | 0.50 | 0.50 | 0.50 | 0.47 | 0.51 |
| Ratio | | | | | | | | | | | | | | | | | | | | |
| Epoxy | Flexural | RTD | GPa | 5.6 | 5.2 | 4.6 | 5.2 | 5.1 | 4.6 | 4.5 | 5.2 | 5.2 | 4.9 | 4.8 | 5.0 | 4.9 | 5.0 | 5.0 | 4.7 | 4.9 |
| Resin | Modulus | | | | | | | | | | | | | | | | | | | |
| Properties | Tg | RTD | ° C. | 158 | 153 | 155 | 159 | 156 | 153 | 152 | 140 | 135 | 135 | 131 | 149 | 130 | 130 | 133 | 148 | 152 |
| | Degree of Cure | | % | 90 | 92 | 93 | 95 | 92 | 92 | 94 | 91 | 92 | 91 | 91 | 92 | 92 | 94 | 94 | 92 | 93 |
| | Viscosity increase at 65° C. | | % | | 1.3 | 1.2 | | | 1.3 | 1.3 | | 1.2 | | | 1.2 | 1.3 | 1.0 | 1.0 | 1.2 | |
| | after 2 hours | | | | | | | | | | | | | | | | | | | |
| CFRP | OHC | RTD | ksi | | 45 | 41 | | 44 | 41 | 40 | 45 | 47 | | 42 | | 44 | | 44 | 42 | |
| Properties | Strength | | | | | | | | | | | | | | | | | | | |

TABLE 4
Working Examples

| | | | Unit | Ex. 18 | Ex. 19 |
|---|---|---|---|---|---|
| Epoxy | Component A | TG3DAS | phr | 95 | 100 |
| | | S-722 | | | |
| | Component B | EPON ® 828 | | | 0 |
| | | Araldite ® MY9655T | | | |
| | | TOREP ® PG01 | | | |
| | | Celloxide ®8000 | | 5 | |
| Curing Agent | Component C | Dyhard ® 100S | | 5 | 2 |
| | Component C | Aradur ® 9664-1 | | 10 | 30 |
| | | Aradur ® 9719-1 | | | |
| Accelerator | Component D | Dyhard ® UR200 | | | |
| (Catalyst) | | Dyhard ® UR400 | | | |
| | | Omicure ® | | 5 | 5 |
| | | U-24M | | | |
| | | Dyhard ® URAcc13 | | | |
| Additive | Thermoplastic | SumikaExcel ® 5003P | | | |
| | | Virantage ® | | 10 | 8 |
| | | VW-10700RFP | | | |
| Active Hydrogen:Epoxy group Molar Ratio | | | | 0.79 | 0.91 |
| Epoxy Resin | Flexural Modulus | RTD | GPa | 5.3 | 5.6 |
| Properties | Tg | RTD | ° C. | 148 | 151 |

| | | | |
|---|---|---|---|
| Degree of Cure | % | 92 | 91 |
| Viscosity increase at 65° C. after 2 hours | % | | |

| | | | |
|---|---|---|---|
| CFRP Properties | OHC Strength | RTD | ksi |

1. An epoxy resin composition for a fiber-reinforced composite material comprising components (A), (B), (C), and (D), wherein the epoxy resin composition has a degree of cure of at least 90% after being cured at 132° C. for 2 hours and a room temperature flexural modulus of at least 4.5 GPa after being cured at 132° C. for 2 hours, wherein components (A), (B), (C), and (D) comprise:
(A) at least 20 phr per 100 phr of total epoxy resin of at least one tetrafunctional amine-based epoxy represented by formula (1), wherein X is a divalent moiety having a molecular weight of at least 15 g/mol and R₁ to R₄ are each independently selected from the group consisting of a hydrogen atom, halogen atoms, C₁ to C₆ alkyl groups, C₁ to C₆ alkoxyl groups, C₁ to C₆ fluoroalkyl groups, cycloalkyl groups, aryl groups, and aryloxyl groups wherein these groups are optionally employed individually or different groups are optionally employed in combination as each of R₁ to R₄; 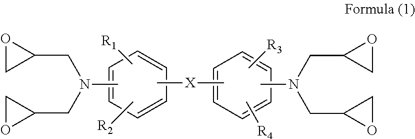
(B) optionally, at most 80 phr per 100 phr of total epoxy resin of at least one epoxy resin other than component (A);
(C) at least one amine-based curing agent, wherein components (A), (B), and (C) are each present in an amount effective to provide a molar ratio of active hydrogens:epoxy groups ranging from 0.2:1 to 0.9:1; and
(D) at least one urea-based catalyst.

2. The epoxy resin composition according to claim 1, wherein X is comprised of at least one heteroatom selected from the group consisting of S, N and O.

3. The epoxy resin composition according to claim 1, wherein X is selected so as to provide the at least one tetrafunctional amine-based epoxy represented by formula (1) with a dipole moment of at least 0.5 Debye.

4. The epoxy resin composition according to claim 1, wherein X is selected from the group consisting of —S—, —S0₂-, —O—, —C(═O)O—, —C(═O)—, —NR₅—, —C(C═O)NR₆C(═O)—, —NR₇C(═O)NR₈—, —OC(═O)NR₉— and —OC(═O)O—, wherein R₅-R₉ are each independently selected from the group consisting of a hydrogen atom, halogen atoms, C₁ to C₆ alkyl groups, C₁ to C₆ alkoxyl groups, C₁ to C₆ fluoroalkyl groups, cycloalkyl groups, aryl groups, and aryloxyl groups.

5. The epoxy resin composition according to claim 1, wherein component (A) is comprised of at least one epoxy resin selected from the group consisting of tetraglycidyl diaminodiphenyl ethers, tetraglycidyl diamino methyldiphenyl ethers, tetraglycidyl diamino dimethyldiphenyl ethers, tetraglycidyl diamino dibromodiphenyl ethers, tetraglycidyl diaminodiphenyl sulfones, tetraglycidyl diamino methyldiphenyl sulfones, tetraglycidyl diamino dimethyldiphenyl sulfones, tetraglycidyl diamino dibromodiphenyl sulfones, tetraglycidyl diaminodiphenyl thioethers, tetraglycidyl diamino benzyl benzoates, tetraglycidyl diamino phenyl benzoates, tetraglycidyl diaminobenzanilides, and combinations thereof.

6. The epoxy resin composition according to claim 1, wherein component (B) is present and is comprised of a component (B1) and a component (B2) which are different from each other.

7. The epoxy resin composition according to claim 6, wherein component (B1) comprises an epoxy resin having more than two epoxy-functional groups per molecule.

8. The epoxy resin composition according to claim 6, wherein component (B2) comprises an epoxy resin having less than three epoxy-functional groups per molecule.

9. The epoxy resin composition according to claim 8, wherein the epoxy resin having less than three epoxy-functional groups per molecule has an average epoxy equivalent weight of less than 205 g/eq.

10. The epoxy resin composition according to claim 8, wherein the epoxy resin having less than three epoxy-functional groups per molecule has an average epoxy equivalent weight of less than 170 g/eq.

11. The epoxy resin composition according to claim 8, wherein component (B2) is present in an amount of at most 30 phr per 100 phr of total epoxy resin.

12. The epoxy resin composition according to claim 1, wherein component (B) comprises at least one tetraglycidyl amine epoxy resin.

13. The epoxy resin composition according to claim 6, wherein component (B1) comprises at least one tetraglycidyl amine epoxy resin and component (B2) comprises at least one epoxy resin selected from the group consisting of bisphenol-A epoxy resins, diglycidylaniline, and cycloaliphatic epoxy resins.

14. The epoxy resin composition according to claim 1, wherein component (C) comprises at least one diaminodiphenyl sulfone or a combination of dicyandiamide and diaminodiphenyl sulfone.

15. The epoxy resin composition according to claim 1, wherein component (C) consists of diaminodiphenyl sulfone which is present in an amount ranging from 10 to 30 phr per 100 phr of total epoxy resin and components (A), (B), and (C) are present in amounts effective to provide a molar ratio of active hydrogens:epoxy groups ranging from 0.2:1 to 0.6:1.

16. The epoxy resin composition according to claim 1, wherein component (C) is comprised of diaminodiphenyl sulfone and dicyandiamide, wherein dicyandiamide is present in an amount of at most 7 phr per 100 phr of total epoxy resin, and components (A), (B), and (C) are present in amounts effective to provide a molar ratio of active hydrogens:epoxy groups ranging from 0.2:1 to 0.9:1.

17. The epoxy resin composition according to claim 1, wherein component (D) comprises at least one urea-based catalyst selected from the group consisting of N,N-dimethyl-N′-(3,4-dichlorophenyl) urea, toluene bis(dimethylurea), 4,4′-methylene bis(phenyl dimethylurea), N-(4-chlorophenyl) N,N-dimethyl urea and 3-phenyl-1,1-dimethylurea.

18. The epoxy resin composition according to claim 1, wherein component (D) is present in an amount ranging from 1 to 8 phr per 100 phr of total epoxy resin.

19. The epoxy resin composition according to claim 1, wherein the epoxy resin composition when cured at 132° C. for 2 hours has a glass transition temperature of at least 130° C.

20. The epoxy resin composition of claim 1, wherein the epoxy resin composition has a viscosity increase less than 2 times the starting viscosity when held at 65° C. for 2 hours.

21. The epoxy resin composition according to claim 1, wherein the epoxy resin composition further comprises at least one thermoplastic resin.

22. The epoxy resin composition according to claim 1, wherein the epoxy resin composition is comprised of at least 5 phr component (B) per 100 phr of total epoxy resin.

23. A prepreg, comprising a reinforcing fiber matrix impregnated with an epoxy resin composition in accordance with claim 1.

24. A fiber-reinforced composite material obtained by curing a prepreg in accordance with claim 23.

25. A fiber-reinforced composite material, comprising a cured epoxy resin product obtained by curing a mixture comprised of an epoxy resin composition in accordance with claim 1 and a reinforcing fiber.

26. A method of making a fiber-reinforced composite material, comprising curing a prepreg in accordance with claim 25 at a temperature of from 110° C. to 150° C.

27. The epoxy resin composition according to claim 16, wherein diaminodiphenyl sulfone is present in an amount ranging from 10 to 30 phr per 100 phr of total epoxy resin.
